(19) United States
(12) Patent Application Publication
(10) Pub. No.: US 2021/0117796 A1
(43) Pub. Date: Apr. 22, 2021

(54) Ship Motion Prediction Method Based on Long Short-Term Memory Network and Gaussian Process Regression

(71) Applicant: Harbin Engineering University, Harbin (CN)

(72) Inventors: Qian SUN, Harbin (CN); Zhong Tang, Harbin (CN); Qianhui Dong, Harbin (CN); Yibing Li, Harbin (CN); Fang Ye, Harbin (CN); Yuan Tian, Harbin (CN); Fei Yu, Harbin (CN)

(21) Appl. No.: 17/136,409

(22) Filed: Dec. 29, 2020

(30) Foreign Application Priority Data
Dec. 1, 2020 (CN) 2020113821454

(51) Int. Cl. G06N 3/08; G06N 3/04

(52) U.S. Cl. CPC G06N 3/08; G06N 3/04

(57) ABSTRACT

The disclosure discloses a ship motion prediction method based on long short-term memory network and Gaussian process regression. The method includes: normalizing acquired ship motion historical data under a certain degree of freedom to form a ship motion original time series; dividing the original time series into a training set and a test set; reconstructing a data set according to the training set and the test set, and establishing a long short-term memory (LSTM) network model for prediction to obtain prediction results of the first ship motion; reconstructing a data set, and establishing a Gaussian process regression (GPR) model for prediction to obtain prediction results of the second ship motion; and denormalizing the prediction results obtained by the Gaussian process regression model to obtain final ship motion prediction results. Aiming at highly non-linear ship motion, the disclosure can obtain ship motion interval prediction results with probability distribution significance while obtaining high-accuracy point prediction results.

### TECHNICAL FIELD

The disclosure belongs to the field of ship and ocean engineering, and specifically relates to a ship motion prediction method based on long short-term memory network and Gaussian process regression.

### BACKGROUND

Due to the action of random and disordered wave forces and other interference forces, ships will have six-degree-of-freedom coupled and very complicated swaying motion, which causes a serious threat to marine operations of the ships. Ship motion prediction refers to the prediction of the motion state of a ship in the future for a period of time based on the current and past motion states of the ship and some known external conditions. The prediction of ship swaying motion can provide safety guarantee for its operations in heavy storms, such as navigation, dynamic positioning and anchoring, and can avoid incidents including ship overturning and dragging caused by improper steering time. The ship motion prediction is also favorable for improving the effectiveness of naval shipborne weapons and equipment. In the design and use of shipborne radar and weapon systems, the impact of ship swaying must be considered, and effective compensation and correction must be made. In addition, the ship motion prediction can ensure the safe take-off and landing of shipborne aircrafts. The ship swaying motion in heavy storms can cause a large displacement of a deck and interfere with the safe take-off and landing of an aircraft, and therefore, the shipborne aircraft must take off and land during the period when the swaying amplitude of a carrier ship is within a safety threshold to effectively avoid accidents in heavy storms.

At present, the research on short-term prediction methods for ship motion attitude is mainly divided into the following four categories: a prediction model based on hydrodynamics, a classical time series prediction model, an artificial intelligence model and a hybrid prediction model. In the prediction model based on hydrodynamics, the wave height at a certain distance in front of the bow is used as an input signal and convolved with the kernel function of ship response, so as to obtain a predicted value of the ship motion attitude. However, this method has very high requirements for the accuracy of the input signal and a response function, the prediction time is short and is generally about 5 seconds, and the prediction accuracy is low. The classical time series prediction model mainly includes three classical models, namely an autoregressive model (AR), a moving average model (MA) and an autoregressive moving average model (ARMA). This type of prediction model builds a time series model for prediction based on the ship motion attitude or historical data of waves to avoid solving ship response functions and state equations, has the advantages of simple operation, high prediction accuracy and strong adaptability, but is difficult to meet the prediction requirements when dealing with non-linear and non-stationary signals. With the development of the artificial intelligence technology, and at the same time, in order to overcome the impact of the non-linear and non-stationary ship motion attitude on the short-term prediction under real sea conditions, some scholars apply the artificial intelligence technology to the short-term prediction of ship motion. This type of model can deal with non-linear and non-stationary signals well, has high prediction accuracy, but has high computation complexity. A single prediction model has different limitations in practical applications and is difficult to meet actual engineering needs, so the hybrid prediction model is gradually developed. The hybrid prediction model usually combines a data preprocessing method and a prediction model or combines multiple prediction models to obtain a hybrid prediction model with a better prediction effect. However, at present, commonly used hybrid prediction models still have problems such as generally high computation complexity, difficulty in selecting model parameters, and lack of adaptability.

### SUMMARY

The disclosure provides a ship motion prediction method based on long short-term memory network and Gaussian process regression. Aiming at highly non-linear ship motion, the disclosure can obtain ship motion interval prediction results with probability distribution significance while obtaining high-accuracy point prediction results, so as to provide a more effective guarantee for the safe operation of ships at sea.

The disclosure is implemented through the following technical solutions:

A ship motion prediction method based on long short-term memory network and Gaussian process regression includes the following steps:

step 1: normalizing acquired ship motion historical data under a certain degree of freedom to form a ship motion original time series;

step 2: dividing the original time series in the step 1 into a training set and a test set;

step 3: reconstructing a data set according to the training set and the test set in the step 2, and establishing a long short-term memory (LSTM) network model for prediction to obtain prediction results of the first ship motion;

step 4: reconstructing a data set according to the step 3, and establishing a Gaussian process regression (GPR) model for prediction to obtain prediction results of the second ship motion; and

step 5: denormalizing the prediction results obtained by the Gaussian process regression model according to the step 3 and the step 4 to obtain final ship motion prediction results.

Further, the normalization formula in the step 1 is:

x(t)′=(x(t)−x(t)ₘᵢₙ)/(x(t)ₘₐₓ−x(t)ₘᵢₙ),

wherein x(t) is original ship motion data, x(t)ₘₐₓ is a maximum value of a series x(t), and x(t)ₘᵢₙ is a minimum value of the series x(t).

Further, in the step 2, the normalized time series is expressed as: F=[F₁, F₂, . . . , F_{Ta+Te}] the series is divided into a training set and a test set which are respectively used for model training and prediction result verification, the training set is expressed as: F^{ta}=[F₁^{ta}, F₂^{ta}, . . . , F_{Ta}^{ta}], and the test set is expressed as: F^{te}=[F₁^{te}, F₂^{te}, . . . , F_{Te}^{te}], wherein the number of the training set and the test set takes different values according to actual conditions.

Further, the step 3 specifically includes the following steps:

step 3.1: reconstructing a first training data set: D₁ₛₜ^{ta}=[X₁ₛₜ^{ta}, Y₁ₛₜ^{ta}],

wherein X₁ₛₜ^{ta}=[x₁^{ta},x₂^{ta}, . . . ,x_{Ta}^{ta}],xₜ^{ta}=[Fₜ₋₁^{ta},Fₜ₋₂^{ta},Fₜ₋₃^{ta} . . . ],

Y₁ₛₜ^{ta}=[Y₁^{ta},Y₂^{ta}, . . . ,Y_{Ta}^{ta}],Yₜ^{ta}=[Fₜ^{ta}]; and

reconstructing a first test data set: D₁ₛₜ^{te}=[X₁ₛₜ^{te}, Y₁ₛₜ^{te}],

wherein X₁ₛₜ^{te}=[x₁^{te},x₂^{te}, . . . ,x_{Te}^{te}],xₜ^{te}=[Fₜ₋₁^{te},Fₜ₋₂^{te},Fₜ₋₃^{te} . . . ],

Y₁ₛₜ^{te}=[Y₁^{te},Y₂^{te}, . . . ,Y_{Te}^{te}],Yₜ^{te}=[Fₜ^{te}];

step 3.2: establishing the long short-term memory (LSTM) network, wherein the network model includes an LSTM layer, the number of nodes in an input layer is the number of feature inputs, the number of nodes in a hidden layer is nₕ, the number of nodes in an output layer is 1, at the time t, the input of the network is a historical ship motion series xₜ^{ta} and the output is a predicted value Yₜ^{ta} at the next time, the output hₜ of the hidden layer is obtained after the hidden layer operation, and the output of the network is:

yᵢ=σ(zᵢ)=σ(w_{y}·hᵢ+b_{y}),

wherein

$$σ ( x ) = y = \frac{1}{1 + {e}^{- x}} ,$$

w_{y} is a weight matrix between the hidden layer and the output layer, b_{y} is an offset of the output layer, and m historical data before the current time is used as the input of the network for training and prediction; and

step 3.3: using the long short-term memory (LSTM) network model obtained in the step 3.2, at this time, inputting [X₁ₛₜ^{ta}, X₁ₛₜ^{te}], and obtaining model output results [y_{1,1}^{ta}, y_{1,2}^{ta}, . . . , y_{1,Ta}^{ta}, y_{1,1}^{te}, y_{1,2}^{te}, . . . , y_{1,Te}^{te}].

Further, the step 4 specifically includes the following steps:

step 4.1: reconstructing a second training data set: D_{2nd}^{ta}=[X_{2nd}^{ta}, Y_{2nd}^{ta}],

wherein X_{2nd}^{ta}=[x₁^{ta},x₂^{ta}, . . . ,x_{Ta}^{ta}],xₜ^{ta}=[y_{1,t}^{ta}],

Y_{2nd}^{ta}=[Y₁^{ta},Y₂^{ta}, . . . ,Y_{Ta}^{ta}],Yₜ^{ta}=[Fₜ^{ta}]; and

reconstructing a second test data set: D_{2nd}^{te}=[X_{2nd}^{te}, Y_{2nd}^{te}],

wherein X_{2nd}^{te}=[x₁^{te},x₂^{te}, . . . ,x_{Te}^{te}],xₜ^{te}=[y_{1,t}^{te}],

Y_{2nd}^{te}=[Y₁^{te},Y₂^{te}, . . . ,Y_{Te}^{te}],Yₜ^{te}=[Fₜ^{te}];

step 4.2: establishing a Gaussian process regression model for the second prediction, and assuming that a regression model with noise is: Y=f(X)+ξ, wherein Y is an observed value, f(X) is a basic function, ξ is Gaussian noise, and ξ˜N(0,σₙ²); and then, obtaining prior distribution of the observed value: Y˜N(0,K(X,X)+σₙ²Iₙ), and joint prior distribution of the observed value Y and the predicted value y:

$$[ \begin{matrix}Y \\ y\end{matrix} ] \text{∼} N ( 0 , [ \begin{matrix}K ( X , X ) + {σ}_{n}^{2} {I}_{n} & K ( X , {x}_{*} ) \\ K ( {x}_{*} , X ) & K ( {x}_{*} , {x}_{*} )\end{matrix} ] ) = N ( 0 , [ \begin{matrix}K & {K}_{*}^{T} \\ {K}_{*} & {K}_{* *}\end{matrix} ] ) ,$$

wherein K(X,X)=(kᵢⱼ) is a symmetric positive definite covariance matrix, κᵢⱼ measures the correlation between xᵢ and xⱼ through a kernel function κ, a square exponential kernel function is:

$${κ}_{ij} = {p}_{1} \cdot exp ( - \frac{{( {x}_{i} - {x}_{j} )}^{2}}{2 {p}_{2}} ) ,$$

p₁ and p₂ parameters are adjustable, K(x_{*},X)=K(X,x_{*})^{T} is a covariance matrix between a test set x_{*} and a training set X, K (x_{*}, x_{*}) is a covariance matrix of the test set itself, and Iₙ is an n-dimensional identity matrix;

step 4.3: thus obtaining posterior distribution of the predicted value y:

y|Y˜N(y̅,σ_{y}²),

wherein, y̅=K_{*}K⁻¹Y, σ_{y}²=K_{**}−K_{*}K⁻¹K_{*}^{T}, a mean vector y̅ is a Gaussian process regression model prediction mean, corresponding to point prediction output, σ_{y}² is a variance of y̅, and then, ship motion interval prediction results with probability distribution significance are obtained; and

step 4.4: setting Gaussian process regression model parameters, using the second reconstructed training data set to train the model, then inputting X_{2nd}^{te}=[x₁^{te}, x₂^{te}, . . . , x_{Te}^{te}], and obtaining model output results [y_{2,1}^{te}, y_{2,2}^{te}, . . . , y_{2,Te}^{te}],

Further, the denormalization formula in the step 5 is:

y(t)′=y(t)ₘᵢₙ+y(t)*(y(t)ₘₐₓ−y(t)ₘᵢₙ),

wherein y(t)ₘᵢₙ is a minimum value of a series y(t), y(t)ₘₐₓ is a maximum value of the series y(t), y(t) is a prediction result output by the Gaussian process regression model, and y(t)′ is a final ship motion prediction result after denormalization.

The disclosure has the following beneficial effects:

By using a long short-term memory neural network to predict non-linear and non-stationary ship motion, compared with a traditional ship prediction method, the disclosure can obtain higher-accuracy prediction results. By using a Gaussian process regression algorithm, the disclosure can obtain ship motion interval prediction results with probability distribution significance while obtaining high-accuracy point prediction results, so as to provide a more effective guarantee for the safe operation of ships at sea. Therefore, the disclosure has engineering application significance.

### BRIEF DESCRIPTION OF FIGURES

FIG. 1 is a flow diagram of a prediction method of the disclosure.

FIG. 2 is actually measured ship motion original data used in the disclosure.

FIG. 3 is a comparison diagram of prediction results using LSTM+GPR and true values.

FIG. 4 is a comparison diagram of prediction results using LSTM and true values.

FIG. 5 is a comparison diagram of prediction results using GPR and true values.

### DETAILED DESCRIPTION

The technical solutions in the examples of the disclosure are clearly and completely described below with reference to the drawings in the examples of the disclosure. It is apparent that the described examples are only a part of the examples of the disclosure, and are not all of the examples. Based on the examples in the disclosure, all other examples obtained by those skilled in the art without creative efforts fall within the protection scope of the disclosure.

### Example 1

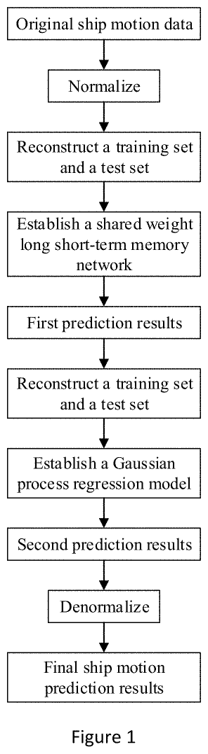

As shown in FIGS. 1-5, a ship motion prediction method based on long short-term memory network and Gaussian process regression includes the following steps:

step 1: normalizing acquired ship motion historical data under a certain degree of freedom to form a ship motion original time series;

step 2: dividing the original time series in the step 1 into a training set and a test set;

step 3: reconstructing a data set according to the training set and the test set in the step 2, and establishing a long short-term memory (LSTM) network model for prediction to obtain prediction results of the first ship motion;

step 4: reconstructing a data set according to the step 3, and establishing a Gaussian process regression (GPR) model for prediction to obtain prediction results of the second ship motion; and

step 5: denormalizing the prediction results obtained by the Gaussian process regression model according to the step 3 and the step 4 to obtain final ship motion prediction results which are convenient for comparison with the original series.

Further, the normalization formula in the step 1 is:

x(t)′=(x(t)−x(t)ₘᵢₙ)/(x(t)ₘₐₓ−x(t)ₘᵢₙ),

wherein x(t) is original ship motion data, x(t)ₘₐₓ is a maximum value of a series x(t), and x(t)ₘᵢₙ is a minimum value of the series x(t),

Further, in the step 2, the normalized time series is expressed as: F=[F₁, F₂, . . . , F_{Ta+Te}], the series is divided into a training set and a test set which are respectively used for model training and prediction result verification, the training set is expressed as: F^{ta}=[F₁^{ta}, F₂^{ta}, . . . , F_{Ta}^{ta}], and the test set is expressed as: F^{te}=[F₁^{te}, F₂^{te}, . . . , F_{Te}^{te}], wherein the number of the training set and the test set takes different values according to actual conditions.

Further, the step 3 specifically includes the following steps:

step 3.1: reconstructing a first training data set: D₁ₛₜ^{ta}=[X₁ₛₜ^{ta}, Y₁ₛₜ^{ta}],

wherein X₁ₛₜ^{ta}=[x₁^{ta},x₂^{ta}, . . . ,x_{Ta}^{ta}],xₜ^{ta}=[Fₜ₋₁^{ta},Fₜ₋₂^{ta},Fₜ₋₃^{ta} . . . ],

Y₁ₛₜ^{ta}=[Y₁^{ta},Y₂^{ta}, . . . ,Y_{Ta}^{ta}],Yₜ^{ta}=[Fₜ^{ta}]; and

reconstructing a first test data set: D₁ₛₜ^{te}=[X₁ₛₜ^{te}, Y₁ₛₜ^{te}],

wherein X₁ₛₜ^{te}=[x₁^{te},x₂^{te}, . . . ,x_{Te}^{te}],xₜ^{te}=[Fₜ₋₁^{te},Fₜ₋₂^{te},Fₜ₋₃^{te} . . . ],

Y₁ₛₜ^{te}=[Y₁^{te},Y₂^{te}, . . . ,Y_{Te}^{te}],Yₜ^{te}=[Fₜ^{te}];

step 3.2: establishing the long short-term memory (LSTM) network, wherein the network model includes an LSTM layer, the number of nodes in an input layer is the number of feature inputs, the number of nodes in a hidden layer is nₕ, the number of nodes in an output layer is 1, at the time t, the input of the network is a historical ship motion series xₜ^{ta} and the output is a predicted value Yₜ^{ta} at the next time, the output hₜ of the hidden layer is obtained after the hidden layer operation, and the output of the network is:

yᵢ=σ(zᵢ)=σ(w_{y}·hᵢ+b_{y}),

wherein

$$σ ( x ) = y = \frac{1}{1 + {e}^{- x}} ,$$

w_{y} is a weight matrix between the hidden layer and the output layer, b_{y} is an offset of the output layer, and m historical data before the current time is used as the input of the network for training and prediction; and

step 3.3: using the long short-term memory (LSTM) network model obtained in the step 3.2, at this time, inputting [X₁ₛₜ^{ta}, X₁ₛₜ^{te}], and obtaining model output results [y_{1,1}^{ta}, y_{1,2}^{ta}, . . . , y_{1,Ta}^{ta}, y_{1,1}^{te}, y_{1,2}^{te}, . . . , y_{1,Te}^{te}].

Further, the step 4 specifically includes the following steps:

step 4.1: reconstructing a second training data set: D_{2nd}^{ta}=[X_{2nd}^{ta}, Y_{2nd}^{ta}],

wherein X_{2nd}^{ta}=[x₁^{ta},x₂^{ta}, . . . ,x_{Ta}^{ta}],xₜ^{ta}=[y_{1,t}^{ta}],

Y_{2nd}^{ta}=[Y₁^{ta},Y₂^{ta}, . . . ,Y_{Ta}^{ta}],Yₜ^{ta}=[Fₜ^{ta}]; and

reconstructing a second test data set: D_{2nd}^{te}=[X_{2nd}^{te}, Y_{2nd}^{te}],

wherein X_{2nd}^{te}=[x₁^{te},x₂^{te}, . . . ,x_{Te}^{te}],xₜ^{te}=[y_{1,t}^{te}],

Y_{2nd}^{te}=[Y₁^{te},Y₂^{te}, . . . ,Y_{Te}^{te}],Yₜ^{te}=[Fₜ^{te}];

step 4.2: establishing a Gaussian process regression model for the second prediction, and assuming that a regression model with noise is: Y=f(X)+ξ, wherein Y is an observed value, f(X) is a basic function, ξ is Gaussian noise, and ξ˜N(0,σₙ²); and then, obtaining prior distribution of the observed value: Y˜N(0,K(X,X)+σₙ²Iₙ), and joint prior distribution of the observed value Y and the predicted value y:

$$[ \begin{matrix}Y \\ y\end{matrix} ] \text{∼} N ( 0 , [ \begin{matrix}K ( X , X ) + {σ}_{n}^{2} {I}_{n} & K ( X , {x}_{*} ) \\ K ( {x}_{*} , X ) & K ( {x}_{*} , {x}_{*} )\end{matrix} ] ) = N ( 0 , [ \begin{matrix}K & {K}_{*}^{T} \\ {K}_{*} & {K}_{* *}\end{matrix} ] ) ,$$

wherein K(X,X)=(kᵢⱼ) is a symmetric positive definite covariance matrix, κᵢⱼ measures the correlation between xᵢ and xⱼ through a kernel function κ, a square exponential kernel function is:

$${κ}_{ij} = {p}_{1} \cdot exp ( - \frac{{( {x}_{i} - {x}_{j} )}^{2}}{2 {p}_{2}} ) ,$$

p₁ and p₂ parameters are adjustable, K(x_{*},X)=K(X,x_{*})^{T} is a covariance matrix between a test set x_{*} and a training set X, K(x_{*}, x_{*}) is a covariance matrix of the test set itself, and Iₙ is an n-dimensional identity matrix;

step 4.3: thus obtaining posterior distribution of the predicted value y:

y|Y˜N(y̅,σ_{y}²),

wherein, y̅=K_{*}K⁻¹Y, σ_{y}²=K_{**}−K_{*}K⁻¹K_{*}^{T}, a mean vector y̅ is a Gaussian process regression model prediction mean, corresponding to point prediction output, σ_{y}² is a variance of y̅, and then, ship motion interval prediction results with probability distribution significance are obtained; and the prediction result of the 95% confidence interval is: [y̅−1.96σ_{y},y̅+1.96σ_{y}]; and

step 4.4: setting Gaussian process regression model parameters, using the second reconstructed training data set to train the model, then inputting X_{2nd}^{te}=[x₁^{te}, x₂^{te}, . . . , x_{Te}^{te}], and obtaining model output results [y_{2,1}^{te}, y_{2,2}^{te}, . . . , y_{2,Te}^{te}].

Further, the denormalization formula in the step 5 is:

y(t)′=y(t)ₘᵢₙ+y(t)*(y(t)ₘₐₓ−y(t)ₘᵢₙ),

wherein y(t)ₘᵢₙ is a minimum value of a series y(t), y(t)ₘₐₓ is a maximum value of the series y(t), y(t) is a prediction result output by the Gaussian process regression model, and y(t)′ is a final ship motion prediction result after denormalization.

### Example 2

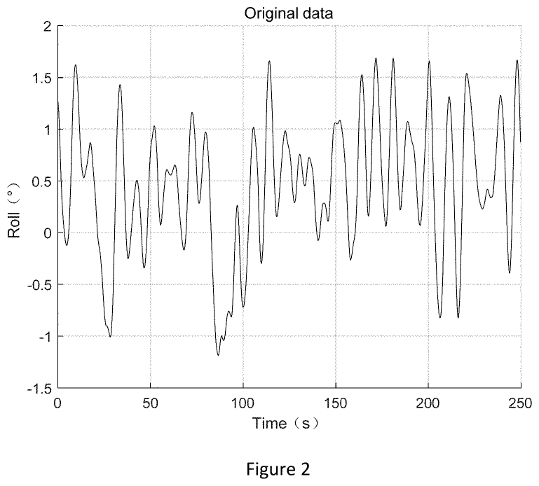

As shown in FIGS. 1-5, sensors installed on a real ship are used to collect a total of 250 s of ship roll angle data when the ship moves at a fixed navigational speed, the sampling frequency is 4 Hz, and there are 1000 data points in total. FIG. 2 is actually measured ship motion original data. The roll angle data is normalized: x(t)′=(x(t)−x(t)ₘᵢₙ)/(x(t)ₘₐₓ−x(t)ₘᵢₙ), wherein x(t) is original ship motion data, x(t)ₘₐₓ is a maximum value of the series x(t), and x(t)ₘᵢₙ is a minimum value of the series x(t)Ta.

The normalized time series is expressed as: F=[F₁, F₂, . . . , F_{Ta+Te}], the series is divided into a training set and a test set which are respectively used for model training and prediction result verification, the training set is expressed as: F^{ta}=[F₁^{ta}, F₂^{ta}, . . . , F_{Ta}^{ta}], and the test set is expressed as: F^{te}=[F₁^{te}, F₂^{te}, . . . , F_{Te}^{te}], wherein the number of the training set and the test set can take different values according to actual conditions. Here, Ta=800, Te=200.

In order to find the mapping relationship between the motion attitude of the ship at the next time and the historical data, the LSTM is used for the first prediction. The specific steps are as follows:

step 3.1: reconstructing the one-dimensional time series, and reconstructing a first training data set: D₁ₛₜ^{ta}=[X₁ₛₜ^{ta}, Y₁ₛₜ^{ta}], wherein

X₁ₛₜ^{ta}=[x₁^{ta},x₂^{ta}, . . . ,x_{Ta}^{ta}],xₜ^{ta}=[Fₜ₋₁^{ta},Fₜ₋₂^{ta},Fₜ₋₃^{ta} . . . ],

Y₁ₛₜ^{ta}=[Y₁^{ta},Y₂^{ta}, . . . ,Y_{Ta}^{ta}],Yₜ^{ta}=[Fₜ^{ta}]; and

reconstructing a first test data set: D₁ₛₜ^{te}=[X₁ₛₜ^{te}, Y₁ₛₜ^{te}], wherein

X₁ₛₜ^{te}=[x₁^{te},x₂^{te}, . . . ,x_{Te}^{te}],xₜ^{te}=[Fₜ₋₁^{te},Fₜ₋₂^{te},Fₜ₋₃^{te} . . . ],

Y₁ₛₜ^{te}=[Y₁^{te},Y₂^{te}, . . . ,Y_{Te}^{te}],Yₜ^{te}=[Fₜ^{te}];

step 3.2: establishing a long short-term memory (LSTM) neural network, wherein the network model includes an LSTM layer, the number of nodes in an input layer is set as the number of feature inputs nₓ=8, the number of nodes in a hidden layer is nₕ=8, the number of nodes in an output layer is 1, at the time t, the input of the network is a historical ship motion series xₜ^{ta} and the output is a predicted value Yₜ^{ta} at the next time, the output hₜ of the hidden layer is obtained after the hidden layer operation, and the output of the network is:

yᵢ=σ(zᵢ)=σ(w_{y}·hᵢ+b_{y})

wherein

$$σ ( x ) = y = \frac{1}{1 + {e}^{- x}} ,$$

w_{y} is a weight matrix between the hidden layer and the output layer, b_{y} is an offset of the output layer, and 8 historical data before the current time is used as the input of the network for training and prediction; and

step 3.3: using the trained LSTM model, inputting [X₁ₛₜ^{ta}, X₁ₛₜ^{te}], and obtaining model output results [y_{1,1}^{ta}, y_{1,2}^{ta}, . . . , y_{1,Ta}^{ta}, y_{1,1}^{te}, y_{1,2}^{te}, . . . , y_{1,Te}^{te}].

In order to find the mapping relationship between the first prediction results and the ship motion historical data, the Gaussian process regression model is used for the second prediction. The specific steps are as follows:

step 4.1: reconstructing a data set by the first prediction results and the original ship motion historical data, and reconstructing a second training data set: D_{2nd}^{ta}=[X_{2nd}^{ta}, Y_{2nd}^{ta}], wherein

X_{2nd}^{ta}=[x₁^{ta},x₂^{ta}, . . . ,x_{Ta}^{ta}],xₜ^{ta}=[y_{1,t}^{ta}],

Y_{2nd}^{ta}=[Y₁^{ta},Y₂^{ta}, . . . ,Y_{Ta}^{ta}],Yₜ^{ta}=[Fₜ^{ta}]; and

reconstructing a second test data set: D_{2nd}^{te}=[X_{2nd}^{te}, Y_{2nd}^{te}], wherein

X_{2nd}^{te}=[x₁^{te},x₂^{te}, . . . ,x_{Te}^{te}],xₜ^{te}=[y_{1,t}^{te}],

Y_{2nd}^{te}=[Y₁^{te},Y₂^{te}, . . . ,Y_{Te}^{te}],Yₜ^{te}=[Fₜ^{te}];

step 4.2: establishing a Gaussian process regression model for the second prediction, and assuming that a regression model with noise is: Y=f(X)+ξ, wherein Y is an observed value, f(X) is a regression function, ξ is Gaussian noise, and ξ˜N(0,σₙ²); and then, obtaining prior distribution of the observed value: Y˜N(0,K(X,X)+σₙ²Iₙ), and joint prior distribution of the observed value Y and the predicted value y:

$$[ \begin{matrix}Y \\ y\end{matrix} ] \text{∼} N ( 0 , [ \begin{matrix}K ( X , X ) + {σ}_{n}^{2} {I}_{n} & K ( X , {x}_{*} ) \\ K ( {x}_{*} , X ) & K ( {x}_{*} , {x}_{*} )\end{matrix} ] ) = N ( 0 , [ \begin{matrix}K & {K}_{*}^{T} \\ {K}_{*} & {K}_{* *}\end{matrix} ] ) ,$$

wherein K(X,X)=(kᵢⱼ) is a symmetric positive definite covariance matrix, κᵢⱼ measures the correlation between xᵢ and xⱼ through a kernel function κ, a square exponential kernel function is:

$${κ}_{ij} = {p}_{1} \cdot exp ( - \frac{{( {x}_{i} - {x}_{j} )}^{2}}{2 {p}_{2}} ) ,$$

p₁ is 2, p₂ is 1, K(x_{*},X)=K(X,x_{*}) is a covariance matrix between a test set x_{*} and a training set X, K(x_{*}, x_{*}) is a covariance matrix of the test set itself, and Iₙ is an n-dimensional identity matrix;

step 4.3: thus obtaining posterior distribution of the predicted value y:

y|Y˜N(y̅,σ_{y}²),

wherein, y̅=K_{*}K⁻¹Y, σ_{y}²=K_{**}−K_{*}K⁻¹K_{*}^{T}, a mean vector y̅ is a Gaussian process process regression model prediction mean, corresponding to point prediction output, σ_{y}² is a variance of y̅, and then, ship motion interval prediction results with probability distribution significance can be obtained; and the prediction result of the 95% confidence interval is: [y̅−1.96σ_{y},y̅+1.96σ_{y}]; and

step 4.4: setting Gaussian process regression model parameters, using the second reconstructed training data set to train the model, then inputting X_{2nd}^{te}=[x₁^{te}, x₂^{te}, . . . , x_{Te}^{te}], and obtaining model output results [y_{2,1}^{te}, y_{2,2}^{te}, . . . , y_{2,Te}^{te}].

The output results of the GPR model are denormalized to obtain final ship motion prediction results which are convenient for comparison with the original series. The denormalization formula is:

y(t)′=y(t)ₘᵢₙ+y(t)*(y(t)ₘₐₓ−y(t)ₘᵢₙ),

wherein y(t)ₘᵢₙ is a minimum value of the series y(t), y(t)ₘₐₓ is a maximum value of the series y(t), y(t) is a prediction result output by the Gaussian process regression model, and y(t)′ is a final ship motion prediction result after denormalization.

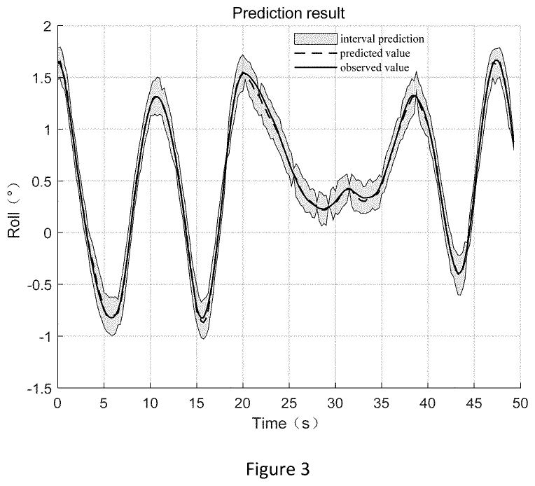

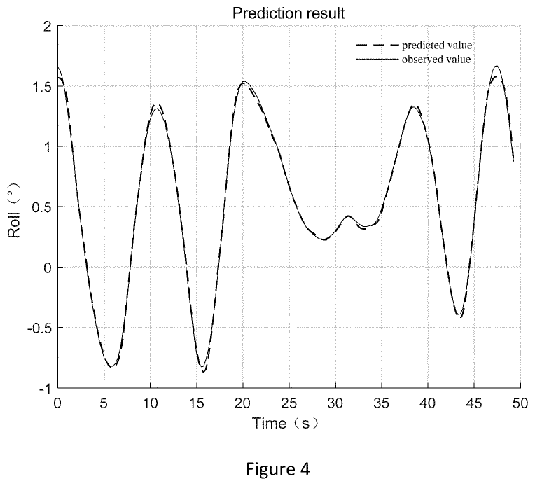

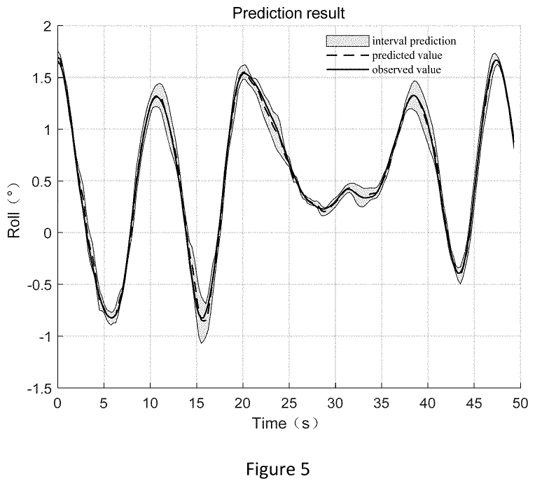

The parameter settings in the above steps are used, three methods are selected for short-term prediction of ship motion, namely, a prediction method based on LSTM and GPR, a prediction method based on LSTM and a prediction method based on GPR, and the prediction results are shown in FIG. 3, FIG. 4 and FIG. 5 respectively. Table 1 summarizes the evaluation indexes of the three prediction methods. It can be seen that the prediction method provided by the disclosure has a certain degree of improvement in prediction accuracy compared with the other two methods, and can provide interval prediction with probability distribution significance while obtaining high-accuracy point prediction results.

TABLE 1
Evaluation indexes of three prediction methods

| Method | RMSE(°) | MAE(°) | MAPE(%) |
|---|---|---|---|
| LSTM-GPR | 0.0246 | 0.0193 | 5.2925 |
| LSTM | 0.0280 | 0.0209 | 6.0961 |
| GPR | 0.0355 | 0.0259 | 9.7306 |

The evaluation indexes in Table 1 are specifically calculated as follows:

RMSE represents a root mean square error, the unit is (°), and the calculation formula is:

$$R M S E = \sqrt{\frac{1}{T e} {\sum }_{i = 1}^{Te} {( {y}_{i} - {Y}_{i} )}^{2}} ;$$

MAE represents a mean absolute error, the unit is (°), and the calculation formula is:

$$MAE = \frac{1}{T e} {\sum }_{i = 1}^{Te} \vert {y}_{i} - {Y}_{i} \vert ;$$

and

MAPE represents a mean absolute percentage error, the unit is (%), and the calculation formula is:

$$M A P E = \frac{1}{T e} {\sum }_{i = 1}^{Te} \vert \frac{{y}_{i} - {Y}_{i}}{{y}_{i}} \vert * 100 \% ,$$

wherein Te represents a total number of test points, yᵢ represents a predicted value, and Yᵢ represents a true value.

What is claimed is:

1. A ship motion prediction method, which is based on long short-term memory (LSTM) network and Gaussian process regression, comprising the following steps:
step 1: normalizing acquired ship motion historical data under a predetermined degree of freedom to form a ship motion original time series;
step 2: dividing the original time series in the step 1 into a training set and a test set;
step 3: reconstructing a data set according to the training set and the test set in the step 2, and establishing a LSTM network model for prediction to obtain prediction results of first ship motion;
step 4: reconstructing a data set according to the step 3, and establishing a Gaussian process regression (GPR) model for prediction to obtain prediction results of second ship motion; and
step 5: denormalizing the prediction results obtained by the GPR model according to the step 3 and the step 4 to obtain final ship motion prediction results.

2. The ship motion prediction method according to claim 1, wherein a normalization formula in the step 1 is:
x(t)′=(x(t)−x(t)ₘᵢₙ)/(x(t)ₘₐₓ−x(t)ₘᵢₙ),
wherein x(t) is original ship motion data, x(t)ₘₐₓ is a maximum value of a series x(t), and x(t)ₘᵢₙ is a minimum value of the series x(t).

3. The ship motion prediction method according to claim 1, wherein in the step 2, the normalized time series is expressed as: F=[F₁, F₂, . . . , F_{Ta+Te}], the series is divided into a training set and a test set, which are used for model training and prediction result verification, respectively, the training set is expressed as: F^{ta}=[F₁^{ta}, F₂^{ta}, . . . , F_{Ta}^{ta}], and the test set is expressed as: F^{te}=[F₁^{te}, F₂^{te}, . . . , F_{Te}^{te}], wherein the number of elements of the training set and the number of elements of the test set take different values according to actual conditions.

4. The ship motion prediction method according to claim 1, wherein the step 3 comprises the following steps:
step 3.1: reconstructing a first training data set: D₁ₛₜ^{ta}=[X₁ₛₜ^{ta}, Y₁ₛₜ^{ta}],
wherein X₁ₛₜ^{ta}=[x₁^{ta},x₂^{ta}, . . . ,x_{Ta}^{ta}],xₜ^{ta}=[Fₜ₋₁^{ta},Fₜ₋₂^{ta},Fₜ₋₃^{ta} . . . ],
Y₁ₛₜ^{ta}=[Y₁^{ta},Y₂^{ta}, . . . ,Y_{Ta}^{ta}],Yₜ^{ta}=[Fₜ^{ta}]; and
reconstructing a first test data set: D₁ₛₜ^{te}=[X₁ₛₜ^{te}, Y₁ₛₜ^{te}],
wherein X₁ₛₜ^{te}=[x₁^{te},x₂^{te}, . . . ,x_{Te}^{te}],xₜ^{te}=[Fₜ₋₁^{te},Fₜ₋₂^{te},Fₜ₋₃^{te} . . . ],
Y₁ₛₜ^{te}=[Y₁^{te},Y₂^{te}, . . . ,Y_{Te}^{te}],Yₜ^{te}=[Fₜ^{te}];
step 3.2: establishing the LSTM network model, wherein the LSTM network model comprises an LSTM layer, the number of nodes in an input layer is the number of feature inputs, the number of nodes in a hidden layer is nₕ, the number of nodes in an output layer is 1, at time t, an input of the network is a historical ship motion series xₜ^{ta} and an output is a predicted value Yₜ^{ta}, at a next time, an output hₜ of the hidden layer is obtained after a hidden layer operation, and the output of the network is:
yᵢ=σ(zᵢ)=σ(w_{y}·hₜ+b_{y}),
wherein
$$σ ( x ) = y = \frac{1}{1 + {e}^{- x}} ,$$
w_{y} is a weight matrix between the hidden layer and the output layer, b_{y} is an offset of the output layer, and m historical data before a current time is used as the input of the network for training and prediction; and
step 3.3: using the LSTM network model obtained in the step 3.2, at this time, inputting [X₁ₛₜ^{ta}, X₁ₛₜ^{te}], and obtaining model output results [y_{1,1}^{ta}, y_{1,2}^{ta}, . . . , y_{1,Ta}^{ta}, y_{1,1}^{te}, y_{1,2}^{te}, . . . , y_{1,Te}^{te}].

5. The ship motion prediction method according to claim 1, wherein the step 4 comprises the following steps:
step 4.1: reconstructing a second training data set: D_{2nd}^{ta}=[X_{2nd}^{ta}, Y_{2nd}^{ta}],
wherein X_{2nd}^{ta}=[x₁^{ta},x₂^{ta}, . . . ,x_{Ta}^{ta}],xₜ^{ta}=[y_{1,t}^{ta}],
Y_{2nd}^{ta}=[Y₁^{ta},Y₂^{ta}, . . . ,Y_{Ta}^{ta}],Yₜ^{ta}=[Fₜ^{ta}]; and
reconstructing a second test data set: D_{2nd}^{te}=[X_{2nd}^{te}, Y_{2nd}^{te}],
wherein X_{2nd}^{te}=[x₁^{te},x₂^{te}, . . . ,x_{Te}^{te}],xₜ^{te}=[y_{1,t}^{te}],
Y_{2nd}^{te}=[Y₁^{te},Y₂^{te}, . . . ,Y_{Te}^{te}],Yₜ^{te}=[Fₜ^{te}];
step 4.2: establishing a GPR model for second prediction, and assuming that a regression model with noise is: Y=f(X)+ξ, wherein Y is an observed value, f(X) is a basic function, ξ is Gaussian noise, and ξ˜N(0,σₙ²); and then, obtaining a prior distribution of the observed value: Y˜N(0,K(X,X)+σₙ²Iₙ), and a joint prior distribution of the observed value Y and the predicted value y:
$$[ \begin{matrix}Y \\ y\end{matrix} ] \text{∼} N ( 0 , [ \begin{matrix}K ( X , X ) + {σ}_{n}^{2} {I}_{n} & K ( X , {x}_{*} ) \\ K ( {x}_{*} , X ) & K ( {x}_{*} , {x}_{*} )\end{matrix} ] ) = N ( 0 , [ \begin{matrix}K & {K}_{*}^{T} \\ {K}_{*} & {K}_{* *}\end{matrix} ] ) ,$$
wherein K(X,X)=(kᵢⱼ) is a symmetric positive definite covariance matrix, κᵢⱼ measures the correlation between xᵢ and xⱼ through a kernel function κ, a square exponential kernel function is:
$${κ}_{ij} = {p}_{1} \cdot exp ( - \frac{{( {x}_{i} - {x}_{j} )}^{2}}{2 {p}_{2}} ) ,$$
p₁ and p₂ parameters are adjustable, K(x_{*},X)=K(X,x_{*})^{T} is a covariance matrix between a test set x_{*} and a training set X, K(x_{*},x_{*}) is a covariance matrix of the test set, and Iₙ is an n-dimensional identity matrix;
step 4.3: obtaining a posterior distribution of the predicted value y:
y|Y˜N(y̅,σ_{y}²),
wherein, y̅=K_{*}K⁻¹Y, σ_{y}²=K_{**}−K_{*}K⁻¹K_{*}^{T}, a mean vector y̅ is a Gaussian process regression model prediction mean, corresponding to point prediction output, σ_{y}² is a variance of y̅, and then, ship motion interval prediction results with probability distribution significance are obtained; and
step 4.4: setting GPR model parameters, using the second reconstructed training data set to train the model, then inputting X_{2nd}^{te}=[x₁^{te}, x₂^{te}, . . . , x_{Te}^{te}], and obtaining model output results [y_{2,1}^{te}, y_{2,2}^{te}, . . . , y_{2,Te}^{te}].

6. The ship motion prediction method according to claim 1, wherein a denormalization formula in the step 5 is:
y(t)′=y(t)ₘᵢₙ+y(t)*(y(t)ₘₐₓ−y(t)ₘᵢₙ),
wherein y(t)ₘᵢₙ is a minimum value of a series y(t), y(t)ₘₐₓ is a maximum value of the series y(t), y(t) is a prediction result output by the GPS model, and y(t)′ is a final ship motion prediction result after denormalization.
